(19) United States
(12) Patent Application Publication
(10) Pub. No.: US 2007/0028144 A1
(43) Pub. Date: Feb. 1, 2007

(54) Systems and methods for checkpointing

(75) Inventors: Simon Graham, Bolton, MA (US); Dan Lussier, Holliston, MA (US)

Correspondence Address: KIRKPATRICK & LOCKHART NICHOLSON GRAHAM LLP, One Lincoln Street, BOSTON, MA, 02111-2950, US

(73) Assignee: Stratus Technologies Bermuda Ltd., Hamilton (BM)

(21) Appl. No.: 11/193,928

(22) Filed: Jul. 29, 2005

(51) Int. Cl. G06F 11/00

(52) U.S. Cl. 714/34

(57) ABSTRACT

The invention relates to checkpointing a disk and/or memory. In one aspect, a first computing device receives a write request that includes a data payload. The first computing device then transmits a copy of the received write request to a second computing device and writes the data payload to a disk. The copy of the write request is queued at a queue on the second computing device until the next checkpoint is initiated or a fault is detected at the first computing device. In another aspect, a processor directs a write request to a location within a first memory. The write request includes at least a data payload and an address identifying the location. An inspection module identifies the write request before it reaches the first memory, copies at least the address identifying the location, and forwards the write request to a memory agent within the first memory.

### TECHNICAL FIELD

The present invention relates to checkpointing protocols. More particularly, the invention relates to systems and methods for checkpointing.

### BACKGROUND

Most faults encountered in a computing device are transient or intermittent in nature, exhibiting themselves as momentary glitches. However, since transient and intermittent faults can, like permanent faults, corrupt data that is being manipulated at the time of the fault, it is necessary to have on record a recent state of the computing device to which the computing device can be returned following the fault.

Checkpointing is one option for realizing fault tolerance in a computing device. Checkpointing involves periodically recording the state of the computing device, in its entirety, at time intervals designated as checkpoints. If a fault is detected at the computing device, recovery may then be had by diagnosing and circumventing a malfunctioning unit, returning the state of the computing device to the last checkpointed state, and resuming normal operations from that state.

Advantageously, if the state of the computing device is checkpointed several times each second, the computing device may be recovered (or rolled back) to its last checkpointed state in a fashion that is generally transparent to a user. Moreover, if the recovery process is handled properly, all applications can be resumed from their last checkpointed state with no loss of continuity and no contamination of data.

Nevertheless, despite the existence of current checkpointing protocols, improved systems and methods for checkpointing the state of a computing device, and/or its component parts, are still needed.

### SUMMARY OF THE INVENTION

The present invention provides systems and methods for checkpointing the state of a computing device, and facilitates the recovery of the computing device to its last checkpointed state following the detection of a fault. Advantageously, the claimed invention provides significant improvements in disk performance on a healthy system by minimizing the overhead normally associated with disk checkpointing. Additionally, the claimed invention provides a mechanism that facilitates correction of faults and minimization of overhead for restoring a disk checkpoint mirror.

In accordance with one feature of the invention, a computing system includes first and second computing devices, which may each include the same hardware and/or software as the other. One of the computing devices initially acts as a primary computing device by, for example, executing an application program and storing data to disk and/or memory. The other computing device initially acts as a secondary computing device with any application programs for execution thereon remaining idle. Preferably, at each checkpoint, the secondary computing device's disk and memory are updated so that their contents reflect those of the disk and memory of the primary computing device.

Accordingly, upon detection of a fault at the primary computing device, processing may resume at the secondary computing device. Such processing may resume from the then current state of the secondary computing device, which represents the last checkpointed state of the primary computing device. Moreover, the secondary computing device may be used to recover, and/or update the state of, the primary computing device following circumvention of the fault at the primary computing device. As such, the computing system of the invention is fault-tolerant.

In general, in one aspect, the present invention relates to systems and methods for checkpointing a disk. A first computing device may receive a write request that is directed to a disk and that includes a data payload. The first computing device may then transmit a copy of the received write request to a second computing device and write the data payload of the received write request to the disk. The copy of the write request may be queued at a queue on the second computing device until the next checkpoint is initiated or a fault is detected at the first computing device. The first computing device may include a data operator for receiving the write request and for writing the data payload to the disk, and may also include a transmitter for transmitting the copy of the write request to the second computing device.

In general, in another aspect, the present invention relates to systems and methods for checkpointing memory. A processor may direct a write request to a location within a first memory. The write request may include a data payload and an address identifying the location. An inspection module may identify the write request before it reaches the first memory, copy the address identifying the location, and forward the write request to a memory agent within the first memory. The location within the first memory may be configured to store the data payload, and the memory agent may be configured to buffer the write request and to forward the data payload to the location.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1 is a block diagram illustrating a computing system for checkpointing a disk according to one embodiment of the invention;

FIG. 2 is a flow diagram illustrating a method for checkpointing the disk;

FIG. 3 is a block diagram illustrating a computing system for checkpointing memory according to another embodiment of the invention; and

FIG. 4 is a flow diagram illustrating a method for checkpointing the memory.

### DETAILED DESCRIPTION OF THE PREFERRED EMBODIMENTS

The present invention relates to checkpointing protocols for fault tolerant computing systems. For example, the present invention relates to systems and methods for checkpointing disk and/or memory operations. In addition, the present invention also relates to systems and methods for recovering (or rolling back) a disk and/or a memory upon the detection of a fault in the computing system.

Disk Operations

One embodiment of the present invention relates to systems and methods for checkpointing a disk. In this embodiment, a computing system includes at least two computing devices: a first (i.e., a primary) computing device and a second (i.e., a secondary) computing device. The second computing device may include the same hardware and/or software as the first computing device. In this embodiment, a write request received at the first computing device is executed (e.g., written to a first disk) at the first computing device, while a copy of the received write request is transmitted to the second computing device. The copy of the write request may be maintained in a queue at the second computing device until the initiation of a checkpoint by, for example, the first computing device, at which point the write request is removed from the queue and executed (e.g., written to a second disk) at the second computing device.

Upon the detection of a fault at the first computing device, the second computing device may be used to recover (or roll back) the first computing device to a point in time just prior to the last checkpoint. Preferably, the write requests that were queued at the second computing device following the last checkpoint are removed from the queue and are not executed at the second computing device, but are used to recover the first computing device. Moreover, upon the detection of a fault at the first computing device, the roles played by the first and second computing devices may be reversed. Specifically, the second computing device may become the new primary computing device and may execute write requests received thereat. In addition, the second computing device may record copies of the received write requests for transmission to the first computing device once it is ready to receive communications. Such copies of the write requests may thereafter be maintained in a queue at the first computing device until the initiation of a checkpoint by, for example, the second computing device.

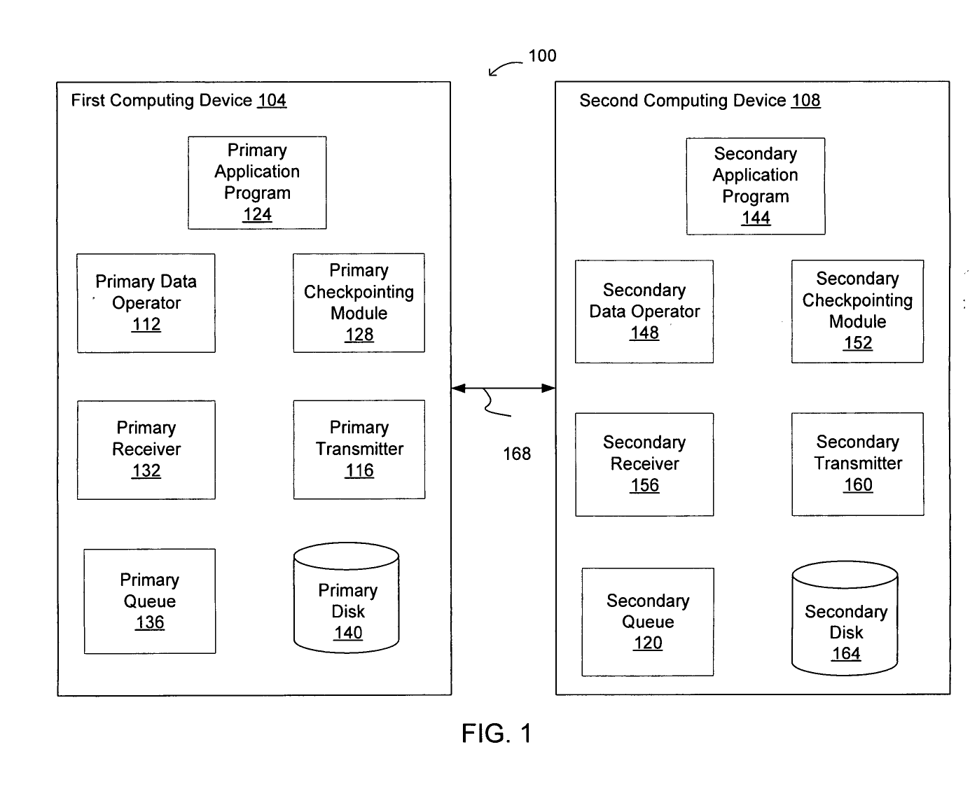

FIG. 1 is a block diagram illustrating a computing system 100 for checkpointing a disk according to this embodiment of the invention. The computing system 100 includes a first (i.e., a primary) computing device 104 and a second (i.e., a secondary) computing device 108. The first and second computing devices 104, 108 can each be any workstation, desktop computer, laptop, or other form of computing device that is capable of communication and that has enough processor power and memory capacity to perform the operations described herein. In one embodiment, the first computing device 104 includes a primary data operator 112 that is configured to receive a first write request, and a primary transmitter 116 that is configured to transmit a copy of the received first write request to the second computing device 108. The second computing device 108 may include a secondary queue 120 that is configured to queue the copy of the first write request until a next checkpoint is initiated or a fault is detected at the first computing device 104.

Optionally, the first computing device 104 can also include a primary application program 124 for execution thereon, a primary checkpointing module 128, a primary receiver 132, a primary queue 136, and a primary disk 140, and the second computing device 108 can also include a secondary application program 144 for execution thereon, a secondary data operator 148, a secondary checkpointing module 152, a secondary receiver 156, a secondary transmitter 160, and a secondary disk 164.

The primary and secondary receivers 132, 156 can each be implemented in any form, way, or manner that is useful for receiving communications, such as, for example, requests, commands, and responses. Similarly, the primary and secondary transmitters 116, 160 can each be implemented in any form, way, or manner that is useful for transmitting communications, such as, for example, requests, commands, and responses. In one embodiment, the receivers 132, 156 and transmitters 116, 160 are implemented as software modules with hardware interfaces, where the software modules are capable of interpreting communications, or the necessary portions thereof. In another embodiment, the primary receiver 132 and the primary transmitter 116 are implemented as a single primary transceiver (not shown), and/or the secondary receiver 156 and the secondary transmitter 160 are implemented as a single secondary transceiver (not shown).

The first computing device 104 uses the primary receiver 132 and the primary transmitter 116 to communicate over a communication link 168 with the second computing device 108. Likewise, the second computing device 108 uses the secondary receiver 156 and the secondary transmitter 160 to communicate over the communication link 168 with the first computing device 104. In one embodiment, the communication link 168 is implemented as a network, for example a local-area network (LAN), such as a company Intranet, or a wide area network (WAN), such as the Internet or the World Wide Web. In one such embodiment, the first and second computing devices 104, 108 can be connected to the network through a variety of connections including, but not limited to, LAN or WAN links (e.g., 802.11, T1, T3), broadband connections (e.g., ISDN, Frame Relay, ATM, fiber channels), wireless connections, or some combination of any of the above or any other high speed data channel. In one particular embodiment, the first and second computing devices 104, 108 use their respective transmitters 116, 160 and receivers 132, 156 to transmit and receive Small Computer System Interface (SCSI) commands over the Internet. It should be understood, however, that protocols other than Internet SCSI (iSCSI) may also be used to communicate over the communication link 168.

The primary application program 124 and the secondary application program 144 may each be any application program that is capable of generating, as part of its output, a write request. In one embodiment, where the primary application program 124 is running, the secondary application program 144 is idle, or in stand-by mode, and vice-versa. In the preferred embodiment, the primary application program 124 and the secondary application program 144 are the same application; the secondary application program 144 is a copy of the primary application program 124.

For their part, the primary and secondary data operators 112, 148, the primary and secondary checkpointing modules 128, 152, and the primary and secondary queues 136, 120 may each be implemented in any form, way, or manner that is capable of achieving the functionality described below. For example, a data operator 112, 148, a checkpointing module 128, 152, and/or a queue 136, 120 may be implemented as a software module or program running on its respective computing device 104, 108, or as a hardware device that is a sub-component of its respective computing device 104, 108, such as, for example, an application specific integrated circuit (ASIC) or a field programmable gate array (FPGA). In addition, each one of the primary and/or secondary queue 136, 120 may be implemented as a first-in-first-out (FIFO) queue. In other words, the oldest information placed in the queue 136, 120 may be the first information removed from the queue 136, 120 at the appropriate time.

The primary disk 140 and the secondary disk 164 may each be any disk that is capable of storing data, for example data associated with a write request. As illustrated, the primary disk 164 may be local to the first computing device 104 and the secondary disk 168 may be local to the second computing device 108. Alternatively, the first computing device 104 may communicate with a primary disk 164 that is remotely located from the first computing device 104, and the second computing device 108 may communicate with a secondary disk 168 that is remotely located from the second computing device 108.

In one embodiment, each unit of storage located within the secondary disk 164 corresponds to a unit of storage located within the primary disk 140. Accordingly, when a checkpoint is processed as described below, the secondary disk 164 is updated so that the contents stored at the units of storage located within the secondary disk 164 reflect the contents stored in the corresponding units of storage located within the primary disk 140. This may be accomplished by, for example, directing write requests to address ranges within the secondary disk 164 that correspond to address ranges within the primary disk 140 that were overwritten since the last checkpoint.

Optionally, the first and/or second computing devices 104, 108 may additionally include other components that interface between and that relay communications between the components described above. For example, a disk subsystem (not shown) may relay communications between an application program 124, 144 and the data operator 112, 148 located on its respective computing device 104, 108. As another example, a bus adapter driver (not shown) may relay communications between a data operator 112, 148 and the disk 140, 164 with which its respective computing device 104, 108 communicates.

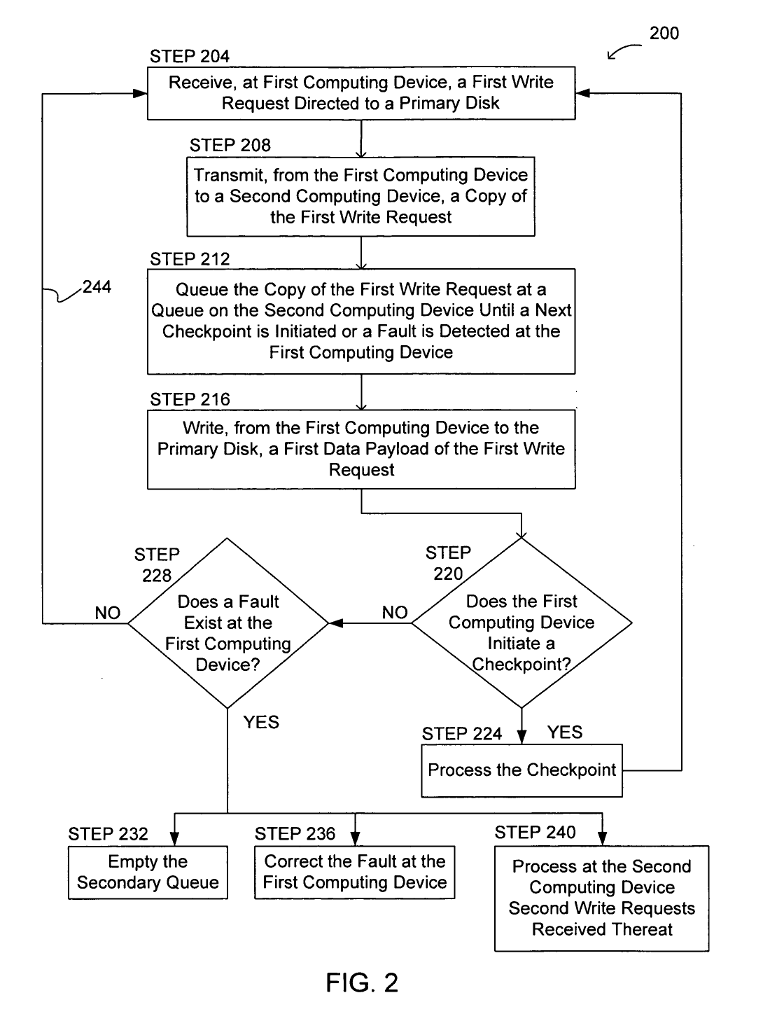

FIG. 2 is a flow diagram illustrating a method 200 for checkpointing the primary disk 140. Using the computing system 100 of FIG. 1, the first computing device 104 receives, at step 204, a first write request that includes a first data payload and that is directed to the primary disk 140, transmits to the second computing device 108, at step 208, a copy of the received first write request. At step 212, the second computing device 108 queues the copy of the first write request until the next checkpoint is initiated or a fault is detected at the first computing device 104. Then, at step 216, the first data payload of the first write request is written to the primary disk 140.

Optionally, the first computing device 104 may initiate, at step 220, a checkpoint. If so, the first and/or second computing devices 104, 108 process the checkpoint at step 224. Asynchronously, as step 224 is being completed, steps 204 through 216 may be repeated. On the other hand, if the first computing device 104 does not initiate a checkpoint at step 220, it is determined, at step 228, whether a fault exists at the first computing device 104. If not, steps 204 through 216 are again performed. If, however, a fault is detected at the first computing device 104, the second computing device 108 proceeds to empty, at step 232, the secondary queue 120, the fault at the first computing device 104 is corrected at step 236, and the second computing device 108 processes, at step 240, second write requests received at the second computing device 108. The performance of steps 232 and 236 may overlap, as may the performance of steps 236 and 240.

In greater detail, in one embodiment, the primary data operator 112 of the first computing device 104 receives, at step 204, the first write request from the primary application program 124 executing on the first computing device 104. Alternatively, in another embodiment, the first write request may be received, for example over a network, from an application program executing on a computing device different from the first computing device 104 and the second computing device 108. The first write request may include an address range identifying the location within the primary disk 140 to which the first write request is directed.

Once the primary data operator 112 of the first computing device 104 receives the first write request at step 204, the primary data operator 112 may issue a copy of the first write request to the primary transmitter 116, which may transmit, at step 208, the copy of the first write request to the second computing device 108. The copy of the first write request is received by, for example, the secondary receiver 156.

The primary data operator 112 may also write, at step 216, the first data payload of the first write request to the primary disk 140. In one embodiment, the primary data operator 112 then stalls processing at the first computing device 104. For example, the primary application program 124 is caused to stop issuing write requests, or, alternatively, the primary data operator 112 stops processing any write requests that it receives.

After the secondary receiver 156 of the second computing device 108 receives the first write request at step 208, an instruction to process the copy of the first write request at the second computing device 108 is preferably issued. For example, an instruction to write the first data payload of the copy of the first write request to the secondary disk 164 may be issued. The secondary checkpointing module 152 then identifies the instruction to process the copy of the first write request at the second computing device 108 and, prior to an execution of that instruction, intercepts the copy of the first write request. In this embodiment, the secondary checkpointing module 152 then transmits, at step 212, the intercepted copy of the first write request to the secondary queue 120. The copy of the first write request (including both the copy of the first data payload and the copy of the address range identifying the location within the primary disk 140 to which the first write request was directed) may be queued at the secondary queue 120 until the next checkpoint is initiated or until a fault is detected at the first computing device 104.

While the copy of the first write request is queued, at step 212, at the secondary queue 120, the second computing device 108 transmits, via its secondary transmitter 160 and over the communication link 168 to the first computing device 104, a confirmation that the first data payload was written by the second computing device 108 to the secondary disk 164. Accordingly, even though the second computing device 108 has not written the first data payload to the secondary disk 164, the first computing device 104, believing that the second computing device 108 has in fact done so, may resume normal processing. For example, the primary application program 124 may resume issuing write requests and/or the primary data operator 112 may resume processing the write requests that it receives.

After completing steps 204 through 216, the primary checkpointing module 128 of the first computing device 104 may initiate, at step 220, a checkpoint. The checkpoint may be initiated after a single iteration of steps 204 through 216, or, alternatively, as represented by feedback arrow 244, steps 204 through 216 may be repeated any number of times before the primary checkpointing module 128 initiates the checkpoint. The primary checkpointing module 128 may be configured to initiate the checkpoint regularly after a pre-determined amount of time (e.g., after a pre-determined number of seconds or a pre-determined fraction of a second) has elapsed since the previous checkpoint was initiated. The primary checkpointing module 128 may initiate the checkpoint by transmitting to the secondary checkpointing module 152, for example via the primary transmitter 116, the communication link 168, and the secondary receiver 156, an instruction initiating the checkpoint.

If the primary checkpointing module 128 does in fact initiate the checkpoint at step 220, the first and/or second computing devices 104, 108 process the checkpoint at step 224. In one embodiment, the secondary checkpointing module 152 inserts, in response to receiving the instruction to initiate the checkpoint from the primary checkpointing module 128, a checkpoint marker into the secondary queue 120. The secondary checkpointing module 152 may then transmit to the first checkpointing module 128, for example via the secondary transmitter 160, the communication link 168, and the primary receiver 132, a response indicating that the checkpoint is complete. Steps 204 through 216 may then be repeated one or more times until the initiation of the next checkpoint or until a fault is detected at the first computing device 104. Asynchronously, as steps 204 through 216 are being repeated, the secondary checkpointing module 152 may complete step 224 by writing to the secondary disk 164 the first data payload of each copy of each first write request that was queued at the secondary queue 120 prior to the initiation of the checkpoint at step 220 (i.e., that was queued at the secondary queue 120 before the insertion of the checkpoint marker into the secondary queue 120).

At step 228, it is determined whether a fault exists at the first computing device 104. A fault may result from, for example, the failure of one or more sub-components on the first computing device 104, or the failure of the entire first computing device 104, and may cause corrupt data to be present in the primary disk 140. A fault may be detected by, for example, either a hardware fault monitor (e.g., by a decoder operating on data encoded using an error detecting code, by a temperature or voltage sensor, or by one device monitoring another identical device) or by a software fault monitor (e.g., by an assertion executed as part of an executing code that checks for out-of-range conditions on stack pointers or addresses into a data structure). If a fault does not exist at the first computing device 104, steps 204 through 216 are again performed. Otherwise, if a fault is detected at the first computing device 104, steps 232, 236, and 240 are performed to re-synchronize the primary disk 140 with the secondary disk 164. In one embodiment, steps 232 and 236 are first performed in parallel to roll the primary disk 140 back to its state as it existed just prior to the initiation of the most recent checkpoint. Steps 236 and 240 are then performed in parallel so that the primary disk 140 is updated to reflect the activity that will have occurred at the secondary disk 164 following the detection of the fault at the first computing device 104 at step 228.

A fault may occur and be detected at the first computing device 104 at various points in time. For example, a fault may occur and be detected at the first computing device 104 subsequent to initiating a first checkpoint at step 220, and subsequent to repeating steps 204 through 216 one or more times following the initiation of the first checkpoint at step 220, but before initiating a second checkpoint at step 220. In such a case, the secondary data operator 148 may remove from the secondary queue 120, at step 232, each copy of each first write request that was queued at the secondary queue 120 subsequent to the initiation of the first checkpoint (i.e., that was queued at the secondary queue 120 subsequent to the insertion of a first checkpoint marker into the secondary queue 120). All such write requests are removed from the secondary queue 120 to effect a rollback to the state that existed when the current checkpoint was initiated.

Any copies of any first write requests that were queued at the secondary queue 120 prior to the initiation of the first checkpoint (i.e., that were queued at the secondary queue 120 prior to the insertion of the first checkpoint marker into the secondary queue 120), if not already processed by the time that the fault is detected at step 228, may be processed by the secondary checkpointing module 152 in due course at step 224 (e.g., the data payloads of those first write requests may be written by the secondary checkpointing module 152 to the secondary disk 164). All such write requests are processed in due course because they were added to the secondary queue 120 prior to the initiation of the most recent checkpoint and are all known, therefore, to contain valid data. It should be noted, however, that to preserve the integrity of the data stored on the primary and secondary disks 140, 164, all such write requests must be processed before the primary disk 140 is rolled back, as described below. In such a fashion, the second computing device 108 empties the secondary queue 120.

The fault at the first computing device 104 is corrected at step 236. In some embodiments, as mentioned earlier, each first write request processed at steps 204 through 216 is directed to an address range located within the primary disk 140, and each such address range, being a part of the write request, is queued at step 216 in the secondary queue 120. Accordingly, the secondary data operator 148 may record, at step 236, when it removes a copy of a first write request from the secondary queue 120 at step 232, the address range located within the primary disk 140 to which that first write request was directed. Each such address range represents a location within the primary disk 140 at which corrupt data may be present. Accordingly, each such address range may be maintained at the second computing device 108, for example in memory, until the first computing device 104 is ready to receive communications. When this happens, to correct the fault at the first computing device 104, the second computing device 108 may transmit to the first computing device 104, via the secondary transmitter 160, each such address range maintained at the second computing device 108. In addition, the second computing device 108 may transmit to the first computing device 104, as immediately described below, the requisite data needed to replace such potentially corrupt data at each such address range.

For each first write request processed at steps 204 through 216 following the initiation of the most recent checkpoint at step 220 and before the detection of the fault at step 228, data stored at the address range located within the primary disk 140 to which that first write request was directed will have been overwritten at step 216 and may be corrupt. However, data stored at a corresponding address range located within the secondary disk 164 will not have been overwritten since the initiation of the most recent checkpoint at step 220 as a result of that first write request being issued at step 204. Rather, the copies of the first write requests to be directed to such corresponding address ranges within the secondary disk 164 will have been queued at the secondary queue 120 at step 212, and then removed by the secondary data operator 148 from the secondary queue 120 at step 232 following the detection of the fault at the first computing device 104 at step 228. Accordingly, data stored at such corresponding address ranges within the secondary disk 164 will be valid. Thus, to correct the fault at the first computing device 104, the second computing device 108 may also transmit to the first computing device 104, via the secondary transmitter 160, the data stored at those corresponding address ranges. Such data may then be written, for example by the primary data operator 112 of the first computing device 104, to all the address ranges within the primary disk 140 at which point one would like to return to the previously checkpointed system. In such a fashion, the primary disk 140 is rolled back to its state as it existed just prior to the initiation of the most recent checkpoint.

The second computing device 108 may also receive, at step 240 and after the fault is detected at the first computing device 104 at step 228, one or more second write requests directed to the secondary disk 164. Like a first write request received at the first computing device 104 at step 204, the second write request may include a second data payload.

In one embodiment, prior to the detection of the fault at the first computing device 104, the secondary application program 144 is idle on the second computing device 108. Once, however, the fault is detected at the first computing device 104, the secondary application program 144 is made active and resumes processing from the state of second computing device 108 as it exists following the completion, at step 224, of the most recent checkpoint. In one such an embodiment, the second data operator 148 of the second computing device 108 receives, at step 240, one or more second write requests from the secondary application program 144. Alternatively, in another embodiment, the second data operator 148 receives at step 240, for example over a network and through the secondary receiver 156, one or more second write requests from an application program executing on a computing device different from the second computing device 108 and the first computing device 104.

Once the secondary data operator 148 receives a second write request at step 240, the secondary data operator 148 may, as part of correcting the fault at the first computing device 104 at step 236, record a copy of the second write request. For example, the copy of the second write request may be maintained, at step 236, in memory on the second computing device 108 until the first computing device 104 is ready to receive communications. After a copy of the second write request is recorded, the secondary data operator 148 may write the second data payload of the second write request to the secondary disk 164. Then, when the first computing device 104 is ready to receive communications, the second computing device 108 may transmit to the first computing device 104, via the secondary transmitter 160, the copy of the second write request. The first computing device 104 may queue the copy of the second write request at the primary queue 136 until the next checkpoint is initiated or a fault is detected on the second computing device 108. When the next checkpoint is in fact initiated by the secondary checkpointing module 152, the primary checkpointing module 128 may process the second write requests queued at the primary queue 136. For example, the primary checkpointing module 128 may write the second data payloads of the second write requests to the primary disk 140, such that the primary disk 140 is updated to reflect the activity that has occurred at the secondary disk 164 following the detection of the fault at the first computing device 104 at step 228.

Following the completion of steps 232, 236, and 240, steps 204 through 216 may be repeated, with the first computing device 104 and the second computing device 108 reversing roles. In greater detail, the second computing device 108 may receive, at step 204, a second write request that includes a second data payload and that is directed to the secondary disk 164, may transmit to the first computing device 104, at step 208, a copy of the received second write request, and may write, at step 216, the second data payload of the second write request to the secondary disk 140. Previously, however, at step 212, the first computing device 104 may queue the copy of the second write request at the primary queue 136 until the second computing device 108 initiates, at step 220, the next checkpoint, or until a fault is detected at the second computing device 108 at step 228.

In such a fashion, the computing system 100 is fault tolerant, and implements a method for continuously checkpointing disk operations.

Memory Operations

Another embodiment of the present invention relates to systems and methods for checkpointing memory. In this embodiment, the computing system includes first and second memories. One or more processors may direct write requests to the first memory, which can store data associated with those write requests thereat. The one or more processors may also initiate a checkpoint, at which point the second memory is updated to reflect the contents of the first memory. Once updated, the second memory contains all the data stored in the first memory as it existed just prior to the point in time at which the last checkpoint was initiated. Accordingly, in the event of failure or corruption of the first memory, the second memory may be used to resume processing from the last checkpointed state, and to recover (or roll back) the first memory to that last checkpointed state.

In accordance with this embodiment of the invention, the second memory may be remotely located from the first memory (i.e., the first and second memories may be present on different computing devices that are connected by a communications channel). Alternatively, the second memory may be local to the first memory (i.e., the first and second memories may be present on the same computing device). To checkpoint the state of the first memory, one or more checkpoint controllers and an inspection module may be used.

Preferably, the inspection module is positioned on a memory channel and in series between the one or more processors and the first memory. The inspection module may be configured to identify a write request directed by a processor to a location within the first memory, and to copy an address included within the write request that identifies the location within the first memory to which the write request is directed. Optionally, the inspection module may also copy the data of the write request, and forward the copied address and data to a first checkpoint controller for use in checkpointing the state of the first memory. Alternatively, the inspection module forwards only the copied address to the first checkpoint controller for use in checkpointing the state of the first memory. In this latter case, the first checkpoint controller then retrieves, upon the initiation of a checkpoint, the data stored at the location within the first memory identified by that copied address, and uses such retrieved data in checkpointing the state of the first memory.

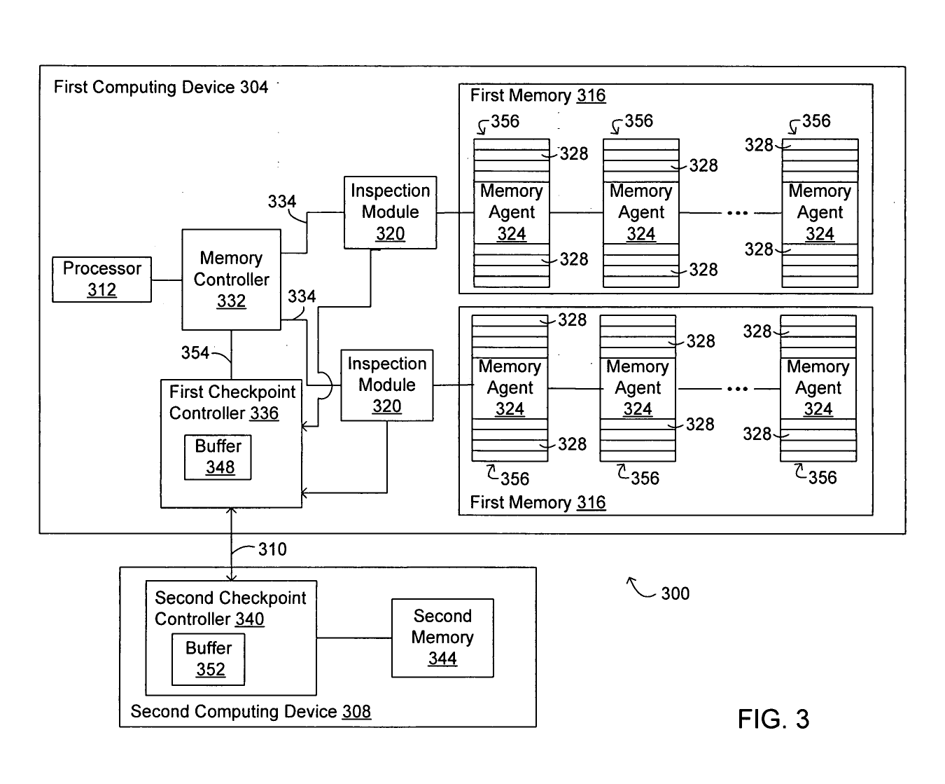

FIG. 3 is a block diagram illustrating a computing system 300 for checkpointing memory according to this embodiment of the invention. The computing system 300 includes a first computing device 304 and, optionally, a second computing device 308 in communication with the first computing device 304 over a communication link 310. The first and second computing devices 304, 308 can each be any workstation, desktop computer, laptop, or other form of computing device that is capable of communication and that has enough processor power and memory capacity to perform the operations described herein. In one embodiment, the first computing device 304 includes at least one processor 312, at least one first memory 316 (e.g., one, two (as illustrated), or more first memories 316), and at least one inspection module 320 (e.g., one, two (as illustrated), or more inspection modules 320). A first memory 316 can include one or more memory agents 324 and a plurality of locations 328 configured to store data.

Optionally, the first computing device 304 may include a memory controller 332, at least one memory channel 334 (e.g., one, two (as illustrated), or more memory channels 334), and a first checkpoint controller 336, and the second computing device 308 may include a second checkpoint controller 340 and at least one second memory 344 in electrical communication with the second checkpoint controller 340. In yet another embodiment, the second computing device 308 is a replica of the first computing device 304, and therefore also includes a processor, a memory controller, and one inspection module positioned on a memory channel for each second memory 344.

The first and second checkpoint controllers 336, 340 may utilize, respectively, first and second buffers 348, 352. In one embodiment, as illustrated in FIG. 3, the first and second buffers 348, 352 are, respectively, sub-components of the first and second checkpoint controllers 336, 340. Alternatively, in another embodiment (not shown), the first and/or second buffer 348, 352 is an element on its respective computing device 304, 308 that is separate from the checkpoint controller 336, 340 of that device 304, 308, and with which the checkpoint controller 336, 340 communicates. The first and/or second buffers 348, 352 may each be implemented as a first-in-first-out (FIFO) buffer. In other words, the oldest information stored in the buffer 348, 352 is the first information to be removed from the buffer 348, 352. In one embodiment, the first checkpoint controller 336 uses the first buffer 348 to temporarily store information that is to be transmitted to the second checkpoint controller 340, but whose transmission is delayed due to bandwidth limitations.

As illustrated in FIG. 3, the processor 312 is in electrical communication, through the memory controller 332 and/or an inspection module 320, with both the first checkpoint controller 336 and the one or more first memories 316. The processor 312 can be any processor known in the art that is useful for directing a write request to a location 328 within a first memory 316 and for initiating a checkpoint. For example, the processor 312 may be [Which processors are most likely to be used?]. In one embodiment, the write request directed by the processor 312 to a location 328 within a first memory 316 includes both a data payload and an address that identifies the location 328.

As illustrated in FIG. 3, the memory controller 332 may be in electrical communication with the processor 312, with the first checkpoint controller 336 via a connection 354, and, through the one or more inspection modules 320, with the first memories 316. In one embodiment, the memory controller 332 receives write requests from the processor 312, and selects the appropriate memory channel 334 over which to direct the write request. In another embodiment, the memory controller 332 receives read requests from the processor 312 and/or, as explained below, the first checkpoint controller 336, reads the data from the appropriate location 328 within the first memory 316, and returns such read data to the requester. The memory controller 332 may be implemented in any form, way, or manner that is capable of achieving such functionality. For example, the memory controller 332 may be implemented as a hardware device, such as an ASIC or an FPGA.

For its part, a first memory 316 can be any memory that includes both i) a plurality of locations 328 that are configured to store data and ii) at least one memory agent 324, but typically a plurality of memory agents 324, that is/are configured to buffer a write request received from the processor 312 and to forward the data payload of the write request to a location 328. For example, a first memory 316 may be provided by using a single, or multiple connected, Fully Buffered Dual In-line Memory Module (FB-DIMM) circuit board(s), which is/are manufactured by Intel Corporation of Santa Clara, Calif. in association with the Joint Electronic Devices Engineering Council (JEDEC). Each FB-DIMM circuit board provides an Advanced Memory Buffer (AMB) and Synchronous Dynamic Random Access Memory (SDRAM), such as, for example, Double Data Rate (DDR)-2 SDRAM or DDR-3 SDRAM. More specifically, the AMB of an FB-DIMM circuit board may serve as a memory agent 324, and the SDRAM of an FB-DIMM circuit board may provide for the plurality of locations 328 within the first memory 316 at which data can be stored.

As illustrated in FIG. 3, a first memory 316 includes a plurality of sections 356. Each section 356 includes a memory agent 324 and a plurality of locations 328. In one such embodiment, the memory agent 324 of adjacent sections 356 are in electrical communication with one another. Accordingly, in one particular embodiment, an FB-DIMM circuit board may be used to implement each one of the plurality of sections 356, with the AMBs of each adjacent FB-DIMM circuit board in electrical communication with one another.

The second memory 344 may be implemented in a similar fashion to the first memory 316. It should be understood, however, that other implementations of the first and/or second memories 316, 344 are also possible.

Referring still to FIG. 3, each first memory 316 is electrically coupled to the processor 312 via a memory channel 334, which may be a high speed memory channel 334, and through the memory controller 332. An inspection module 320 is preferably positioned on each memory channel 334 and in series between the processor 312 and the first memory 316 (e.g., a memory agent 324 of the first memory 316) to which that memory channel 324 connects. Accordingly, in this embodiment, for a write request directed by the processor 312 to a first memory 316 to reach the first memory 316, the write request must first pass through an inspection module 320.

For its part, an inspection module 320 may be implemented as any hardware device that is capable of identifying a write request directed by the processor 312 to a location 328 within the first memory 316, and that is further capable, as described below, of examining, handling, and forwarding the write request or at least one portion thereof. For example, in one particular embodiment, the AMB manufactured by Intel Corporation of Santa Clara, Calif. is used by itself (i.e., separate and apart from an FB-DIMM circuit board and its associated SDRAM) to implement the inspection module 320. More specifically, in one such particular embodiment, the logic analyzer interface of the AMB may be used to capture write requests directed by the processor 312 to the first memory 316, and to forward the address and/or data information associated with such write requests to the first checkpoint controller 336.

For their part, the first and second checkpoint controllers 336, 340 may each be implemented in any form, way, or manner that is capable of achieving the functionality described below. For example, the checkpoint controllers 336, 340 may each be implemented as any hardware device, or as any software module with a hardware interface, that is capable of achieving, for example, the checkpoint buffering, control, and communication functions described below. In one particular embodiment, a customized PCI-Express card is used to implement one or both of the checkpoint controllers 336, 340.

In one embodiment, the first checkpoint controller 336 is in electrical communication with each inspection module 320, and with the memory controller 332. The first checkpoint controller 336 may also be in electrical communication with the second checkpoint controller 340 on the second computing device 308 via the communication link 310. In such a case, the second checkpoint controller 340 and the second memory 344 are remotely located from the one or more first memories 316.

The communication link 310 may be implemented as a network, for example a local-area network (LAN), such as a company Intranet, or a wide area network (WAN), such as the Internet or the World Wide Web. In one such embodiment, the first and second computing devices 304, 308 can be connected to the network through a variety of connections including, but not limited to, standard telephone lines, LAN or WAN links (e.g., 802.11, T1, T3, 56 kb, X.25), broadband connections (e.g., ISDN, Frame Relay, ATM), wireless connections, or some combination of any or all of the above.

In an alternate embodiment (not shown), the computing system 300 does not include the second computing device 308. In such an embodiment, the first computing device 304 includes one or more second memories 344 (i.e., the one or more second memories 344 is/are local to the one or more first memories 316), and the first checkpoint controller 336 is in electrical communication with those one or more second memories 344.

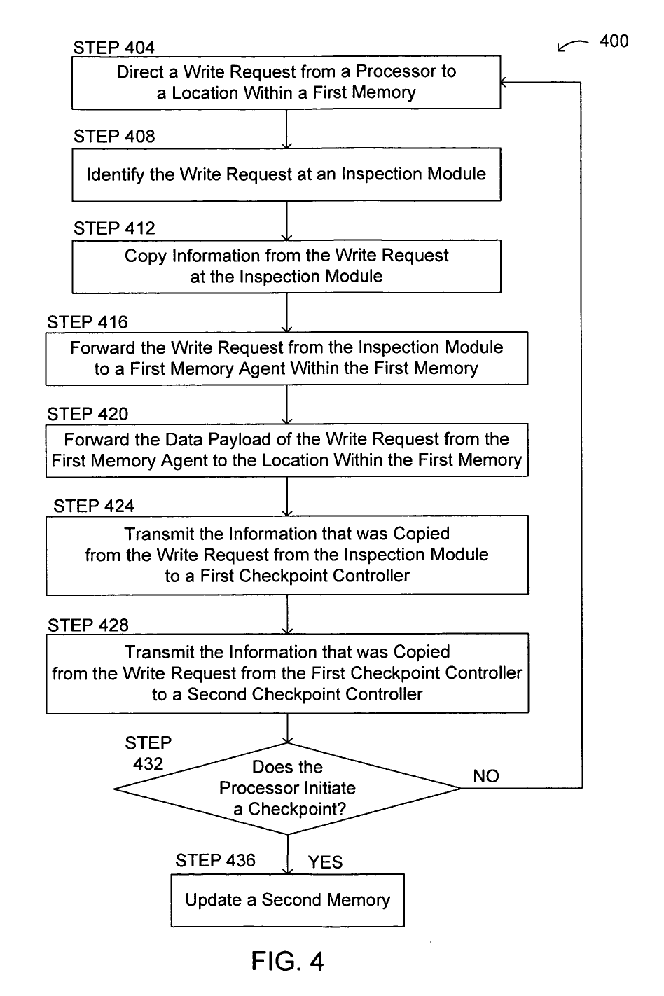

FIG. 4 is a flow diagram illustrating a method 400 for checkpointing the first memory 316. Using the computing system 300 of FIG. 3, the processor 312 first directs, at step 404, a write request to a location 328 within a first memory 316. At step 408, the write request is identified at an inspection module 320. The inspection module 320 then copies, at step 412, information from the write request (e.g., the address that identifies the location 328 within the first memory 316 to which the write request is directed), and forwards, at step 416, the write request to a first memory agent 324 within the first memory 316. Upon receiving the write request, the first memory agent 324 may extract the data payload from the write request and forward, at step 420, that data payload to the location 328 within the first memory 316 for storage thereat.

Optionally, the inspection module 320 may transmit to the first checkpoint controller 336, at step 424, the information that was copied from the write request at step 412, the first checkpoint controller 336 may transmit that copied information to the second checkpoint controller 340 at step 428, and the processor 312 may initiate a checkpoint at step 432. If the processor 312 initiates a checkpoint at step 432, the second memory 344 may be updated at step 436. Otherwise, if the processor 312 does not initiate a checkpoint at step 432, steps 404 through 428 may be repeated one or more times.

In greater detail, when the inspection module 312 identifies the write request at step 408, the inspection module 312 may buffer the write request thereat before forwarding, at step 416, the write request to the first memory agent 324. This buffering may facilitate, for instance, copying the information from the write request at step 412. Similarly, upon receiving the write request at step 416, the memory agent 324 may buffer the write request thereat before forwarding, at step 420, the data payload to the location 328 within the first memory 316. This buffering may facilitate the decoding and processing of the write request by the first memory agent 324. In forwarding, at step 420, the data payload to the location 328 within the first memory 316, the data payload and other information associated with the write request may first be forwarded from one memory agent 324 to another, until the data payload is present at the memory agent 324 in the section 356 at which the location 328 is present.

As mentioned, the inspection module 312 copies, at step 412, information from the write request. In one embodiment, the inspection module 312 copies only the address that identifies the location 328 within the first memory 316 to which the write request is directed. In another embodiment, in addition to copying this address, the inspection module 312 also copies the data payload of the write request. In yet another embodiment, the inspection module 312 copies the entire write request (i.e., the address, the data payload, and any other information associated with the write request, such as, for example, control information) at step 412.

After having copied the information from the write request at step 412, the inspection module 312 may transmit, at step 424, the copied information to the first checkpoint controller 336. Accordingly, the inspection module 312 may transmit the copy of the address, the copy of the address and the copy of the data payload, or the copy of the entire write request to the first checkpoint controller 336. The first checkpoint controller 336 may then store the copied information, which it receives from the inspection module 320, at the first buffer 348 utilized by the first checkpoint controller 336.

Where the inspection module 320 only copies, and only forwards to the first checkpoint controller 336, the address from the write request, the first checkpoint controller 336 may itself read data stored at the location 328 within the first memory 316 to obtain a copy of the data payload. The particular location 328 from which the first checkpoint controller 336 reads the data payload may be identified by the address that the first checkpoint controller 336 receives from the inspection module 320. In one such embodiment, the first checkpoint controller 336 reads the data by issuing a read request to the memory controller 332 via the connection 354, and by receiving a response from the memory controller 332 across the connection 354. Moreover, in such an embodiment, each inspection module 320 may be configured to ignore/pass on read requests directed by the memory controller 332 across the memory channel 334 on which the inspection module 320 is positioned. Each inspection module 340 may also be configured to ignore/pass on each response to a read request returned by a first memory 316 to the memory controller 332. Accordingly, in this implementation, because an inspection module 320 does not directly transmit data to the first checkpoint controller 336, the required bandwidth between the inspection module 320 and the first checkpoint controller 336 is reduced. Such an implementation could be used, for example, where performance demands are low and where system bandwidth is small.

In one embodiment of this implementation, the first checkpoint controller 336 reads the data from the location 328 within the first memory 316 immediately upon receiving the copy of the address from the inspection module 320. In other embodiments, the first checkpoint controller 336 buffers the received address in the first buffer 348 and reads the data from the location 328 when it is ready to, or is preparing to, transmit information at step 428, or when it is ready to, or is preparing to, update the second memory 344 at step 436. In some cases, upon reading the data, the first checkpoint controller 336 stores the data in the first buffer 348.

Where the computing system 300 includes the second computing device 308 (i.e., where the second memory 344 is remote from the first memory 316), the first checkpoint controller 336 may transmit to the second checkpoint controller 340, at step 428, the copy of the address and the copy of the data payload, or, alternatively, the copy of the entire write request. In one embodiment, the first checkpoint controller 336 transmits such information to the second checkpoint controller 340 in the order that it was initially stored in the first buffer 348 (i.e., first-in-first-out). Moreover, such information may be continuously transmitted by the first checkpoint controller 336 to the second checkpoint controller 340, at a speed determined by the bandwidth of the communication link 310. Upon receiving the copy of the address and the copy of the data payload, or, alternatively, the copy of the entire write request, the second checkpoint controller 340 may store such information in the second buffer 352. In one embodiment, the second checkpoint controller 340 continues to store such information in the second buffer 352, and does not write the copy of the data payload to the second memory 344, until a checkpoint marker is received, as discussed below, from the first checkpoint controller 336.

Alternatively, in another embodiment, where the computing system 300 does not include the second computing device 308 (i.e., where the second memory 344 is local to the first memory 316), step 428 is not performed. Rather, the first checkpoint controller 336 continues to store the copy of the address and the copy of the data payload, or, alternatively, the copy of the entire write request, in the first buffer 348 until the second memory 344 is to be updated at step 436.

At step 432, the processor 312 may initiate a checkpoint. If so, the second memory 344 is updated at step 436. Otherwise, if the processor 312 does not initiate a checkpoint at step 432, steps 404 through 428 may be repeated one or more times. In one embodiment, to initiate the checkpoint, the processor 312 transmits, to the first checkpoint controller 336, a command to insert a checkpoint marker into the first buffer 348. The first checkpoint controller 336 then inserts the checkpoint marker into the first buffer 348. Because, as described above, the first buffer 348 may be implemented as a FIFO buffer, placement of the checkpoint marker in the first buffer 348 can indicate that all data placed in the first buffer 348 prior to the insertion of the checkpoint marker is valid data that should be stored to the second memory 344. The first checkpoint controller 336 may transmit the checkpoint marker to the second checkpoint controller 340 in the first-in-first-out manner described above with respect to step 428. More specifically, the first checkpoint controller 336 may transmit the checkpoint marker to the second checkpoint controller 340 after transmitting any information stored in the first buffer 348 prior to the insertion of the checkpoint marker therein, but before transmitting any information stored in the first buffer 348 subsequent to the insertion of the checkpoint marker therein.

At step 436, the second memory 344 is updated. In one embodiment, upon receipt of the checkpoint marker at the second checkpoint controller 340, the second checkpoint controller 340 directs the second memory 344 to store, at the appropriate address, each copy of each data payload that was stored in the second buffer 352 prior to the receipt of the checkpoint marker at the second checkpoint controller 340. Alternatively, in another embodiment, where the computing system 300 does not include the second computing device 308 (i.e., where the second memory 344 is local to the first memory 316), the first checkpoint controller 336 directs the second memory 344 to store, at the appropriate address, each copy of each data payload that was stored in the first buffer 348 prior to the insertion of the checkpoint marker into the first buffer 348. In one such embodiment, the first checkpoint controller 336 transmits each such copy of the data payload to the second memory 344. Accordingly, in either embodiment, the state of the second memory 344 reflects the state of the first memory 316 as it existed just prior to the initiation of the checkpoint by the processor 312.

In such a fashion, the computing system 300 implements a method for continuously checkpointing memory operations. Thus, in the event that corrupt data is determined to be present in the first memory 316, processing may resume from the state of the second memory 344, which itself reflects the state of the first memory as it existed just prior to the initiation of the last checkpoint. In the embodiment where the second memory 344 is remotely located from the first memory 316 on the second computing device 308, such processing may resume on the second computing device 308.

In yet another embodiment, where corrupt data is determined to be present in the first memory 316, the first memory 316 may be recovered using the second memory 344.

The systems and methods described herein provide many advantages over those presently available. For example, the claimed invention provides significant improvements in disk performance on a healthy system by minimizing the overhead normally associated with disk checkpointing. Additionally, the claimed invention provides a mechanism that facilitates correction of faults and minimization of overhead for restoring a disk checkpoint mirror. There are also many other advantages and benefits of the claimed invention which will be readily apparent to those skilled in the art.

Variations, modification, and other implementations of what is described herein will occur to those of ordinary skill in the art without departing from the spirit and scope of the invention as claimed. Accordingly, the invention is to be defined not by the preceding illustrative description but instead by the spirit and scope of the following claims.

What is claimed is:

1. A method for checkpointing a disk, the method comprising:
(a) receiving, at a first computing device, a first write request directed to a first disk, the first write request comprising a first data payload;
(b) transmitting, from the first computing device to a second computing device, a copy of the first write request;
(c) writing, from the first computing device to the first disk, the first data payload of the first write request; and
(d) queuing the copy of the first write request at a queue on the second computing device until a next checkpoint is initiated or a fault is detected at the first computing device.

2. The method of claim 1 further comprising identifying an instruction to process the copy of the first write request at the second computing device.

3. The method of claim 2 further comprising intercepting the copy of the first write request prior to an execution of the instruction to process the copy of the first write request at the second computing device.

4. The method of claim 1 further comprising transmitting, from the second computing device to the first computing device while the copy of the first write request is queued on the second computing device, a confirmation that the first data payload was written by the second computing device to a second disk.

5. The method of claim 1 further comprising initiating a first checkpoint after completing steps (a), (b), (c), and (d).

6. The method of claim 5 further comprising repeating steps (a), (b), (c), and (d) at least once prior to initiating the first checkpoint.

7. The method of claim 5, wherein initiating the first checkpoint comprises transmitting, from the first computing device to the second computing device, an instruction initiating the first checkpoint.

8. The method of claim 5, wherein initiating the first checkpoint comprises inserting a checkpoint marker into the queue on the second computing device.

9. The method of claim 5 further comprising writing, from the second computing device to a second disk, the first data payload of the copy of the first write request that was queued on the second computing device prior to the initiation of the first checkpoint.

10. The method of claim 5 further comprising transmitting, from the second computing device to the first computing device, a response indicating that the first checkpoint is complete.

11. The method of claim 5 further comprising repeating steps (a), (b), (c), and (d) subsequent to initiating the first checkpoint.

12. The method of claim 11 further comprising detecting the fault at the first computing device subsequent to initiating the first checkpoint.

13. The method of claim 12 further comprising removing from the queue on the second computing device, upon detecting the fault at the first computing device, the copy of the first write request that was queued subsequent to the initiation of the first checkpoint.

14. The method of claim 12 further comprising correcting the fault at the first computing device.

15. The method of claim 14, wherein the first write request is directed to a first address range located within the first disk, and wherein correcting the fault at the first computing device comprises recording, at the second computing device, and for the first write request whose copy was queued at the queue subsequent to the initiation of the first checkpoint, the first address range located within the first disk to which that first write request was directed.

16. The method of claim 15, wherein correcting the fault at the first computing device further comprises transmitting, from the second computing device to the first computing device, the first address range located within the first disk to which the first write request, whose copy was queued at the queue subsequent to the initiation of the first checkpoint, was directed.

17. The method of claim 14, wherein correcting the fault at the first computing device comprises transmitting, from the second computing device to the first computing device, data stored at a second address range located within a second disk.

18. The method of claim 14 further comprising receiving, at the second computing device after detecting the fault at the first computing device, a second write request directed to a second disk, the second write request comprising a second data payload.

19. The method of claim 18 further comprising writing, from the second computing device to the second disk, the second data payload of the second write request.

20. The method of claim 18, wherein correcting the fault at the first computing device comprises maintaining, at the second computing device, a copy of the second write request.

21. The method of claim 20, wherein correcting the fault at the first computing device further comprises transmitting, from the second computing device to the first computing device, the copy of the second write request.

22. A system for checkpointing a disk, the system comprising:
a first computing device comprising
a first data operator configured to receive a first write request directed to a first disk, the first write request comprising a first data payload, and to write the first data payload to the first disk; and
a first transmitter configured to transmit a copy of the first write request to a second computing device; and
the second computing device comprising
a queue configured to queue the copy of the first write request until a next checkpoint is initiated or a fault is detected at the first computing device.

23. The system of claim 22, wherein the second computing device further comprises a checkpointing module configured to identify an instruction to process the copy of the first write request at the second computing device.

24. The system of claim 23, wherein the checkpointing module is further configured to intercept the copy of the first write request prior to an execution of the instruction to process the copy of the first write request at the second computing device.

25. The system of claim 24, wherein the checkpointing module is further configured to transmit the intercepted copy of the first write request to the queue.

26. The system of claim 22, wherein the second computing device further comprises a second transmitter configured to transmit to the first computing device, while the copy of the first write request is queued at the queue, a confirmation that the first data payload was written to a second disk.

27. The system of claim 22, wherein the first computing device further comprises a first checkpointing module configured to initiate a first checkpoint.

28. The system of claim 27, wherein the second computing device further comprises a second checkpointing module in communication with the first checkpointing module, and wherein the first checkpointing module is further configured to transmit an instruction initiating the first checkpoint to the second checkpointing module.

29. The system of claim 28, wherein the second checkpointing module is configured to insert, in response to the instruction initiating the first checkpoint, a checkpoint marker into the queue.

30. The system of claim 28, wherein the second checkpointing module is configured to transmit, to the first checkpointing module, a response indicating that the first checkpoint is complete.

31. The system of claim 27, wherein the second computing device further comprises a second checkpointing module configured to write, after the first checkpoint is initiated, the first data payload of the copy of the first write request to a second disk.

32. The system of claim 22, wherein the second computing device further comprises a second data operator configured to remove from the queue, when the fault is detected at the first computing device, the copy of the first write request.

33. The system of claim 32, wherein the first write request is directed to a first address range located within the first disk, and wherein the second data operator is further configured to record, after the fault is detected at the first computing device and when the copy of the first write request is removed from the queue, the first address range located within the first disk to which the first write request was directed.

34. The system of claim 33, wherein the second computing device further comprises a second transmitter configured to transmit, to the first computing device, the first address range located within the first disk to which the first write request was directed.

35. The system of claim 22, wherein the second computing device further comprises a second transmitter configured to transmit to the first computing device, after the fault is detected at the first computing device, data stored at an address range located within a second disk.

36. The system of claim 22, wherein the second computing device further comprises a second data operator configured to receive, after the fault is detected at the first computing device, a second write request directed to a second disk, the second write request comprising a second data payload.

37. The system of claim 36, wherein the second data operator is further configured to write the second data payload of the second write request to the second disk.

38. The system of claim 36, wherein the second data operator is further configured to record a copy of the second write request.

39. The system of claim 38, wherein the second computing device further comprises a second transmitter configured to transmit the copy of the second write request to the first computing device.
